(19) United States
(12) Patent Application Publication
(10) Pub. No.: US 2006/0051494 A1
(43) Pub. Date: Mar. 9, 2006

(54) Method, device and system for the temporary marking of objects

(75) Inventors: Edgar Muller, Fribourg (CH); Thomas Tiller, Bussigny (CH); Xavier Marguerettaz, Martigny (CH); Myron Seto, Rue (CH)

Correspondence Address: SHOEMAKER AND MATTARE, LTD, 10 POST OFFICE ROAD - SUITE 110, SILVER SPRING, MD, 20910, US

(73) Assignee: SICPA Holding S.A., Prilly (CH)

(21) Appl. No.: 10/540,986

(22) PCT Filed: Sep. 24, 2003
(86) PCT No.: PCT/EP03/10614

§ 371 Date: Jun. 27, 2005

(30) Foreign Application Priority Data
Jan. 17, 2003 (EP) 03001013.6

(51) Int. Cl. B05D 5/00; G06K 19/00

(52) U.S. Cl. 427/5; 235/487; 427/256; 118/688

(57) ABSTRACT

The invention concerns a method, a device and a system for applying a detectable temporary mark of predefined life time of minutes to hours onto an object (0). The invention also concerns a coating composition comprising a short-lived radioactive isotope and the use of a short-lived radioactive isotope as a temporary marking. The temporary mark is applied to the object (O) by the means of a coating composition (3) comprising a low level of a short-lived radionuclide, generated in situ from a longer-lived precursor nucleus. The marking device comprises a radionuclide generator (1), a reservoir (2) for the in situ preparing the radioactively marked printing ink, and an ink-jet or alike printing or spraying head (8), preferably of the dropon-demand type. The marking is preferably detected and identified by a gamma-radiation counter. The invention claims also a system for the temporary marking of an object (O) with a radioactive isotope of predefined life time of minutes to hours, in view of performing an operation on the marked object (O) at a later point in time.

### FIELD OF INVENTION

The invention is in the field of marking and identifying objects. It is in particular about a method, a device and a system for applying an invisible mark which is lasting and detectable only during a determined time.

### STATE OF THE ART

The marking of objects for identification and authentication purposes is known in the art, and a large variety of physical effects have been exploited to this aim, such as the marking of documents or goods with special inks, containing e.g. one or several UV-luminescent compounds. Such markings remain invisible to the unaided eye and can only be evidenced by irradiation with appropriate UV-light. The said kind of marking has also the property of being permanent, lasting over the whole life of the correspondingly marked banknote, passport, credit card, branded good, etc.

In some cases, a temporary marking of documents or goods is required, e.g. for distinction purposes in a process chain, wherein a marking, indicating a distinction, is applied to determined objects in a first part of the process, and an action, corresponding to the said distinction, is performed on the marked objects in a second part of the process, whereby the said second part of the process is performed at a later point in time at another location. The marking, having the only aim to indicate that the said action is to be performed on the marked object, must in general be removed after the action has been performed.

In the easiest case, the said marking may be a simple color mark or a label, and the said removal of the marking may be performed by a simple cleaning operation. There are, however, more delicate applications, where the marking should remain invisible, where it should be read-able by a machine, and where it has to disappear of its own after a determined time, due to the impossibility of removing it by a cleaning operation.

The stated technical problem requires to all evidence some sort of intrinsic timing mechanism to be put in place. Chemical timing, taking profit of a suitable chemical reaction under the influence of temperature, light, oxygen or humidity, is not sufficiently reliable, because chemical reaction rates are very dependent on temperature and on possible catalytic influences of the substrate to which the marking was applied. A similar reasoning holds for a timing based on the physical evaporation or diffusion of a marker compound. Evaporation and diffusion processes are, like chemical reactions, very environment- and temperature-dependent. Furthermore, because the marker compound does not really disappear in these processes, a cross-contamination of unmarked objects through their contact with a marked object might result.

An invisible marking which is detectable by instrumental means and which fades away in time by its own in a foreseeable manner, has not been disclosed up to now.

Although some applications of radioactive isotopes for marking purposes have been disclosed in the prior art, such as in U.S. Pat. No. 3,805,067, “Method of secretly marking a surface employing fission products”, in U.S. Pat. No. 3,959,630, “Identity card having radioactive isotope of short half-life”, and in WO 02/00440 A2, none of these disclosures has addressed the above stated technical problem. The cited documents describe a tedious and time-consuming implantation of radioactive fission products, within the material.

### SUMMARY OF THE INVENTION

The only absolute and environment-influence independent intrinsic timing mechanisms known in nature are the “atomic decay clocks” of radioactive isotopes. The stated technical problem is thus solved according to the invention by a marking of the said object with a short-lived radioactive isotope.

According to the present invention the method of temporary marking an object comprises the step of applying a coating composition which comprises an appropriate, short-lived radioactive isotope. In the context of the invention the term “short-lived” is defined as a half-life time of the radioactive isotope which ranges between a minute and a day, preferably between a plurality of minutes and a plurality of hours. The radioactive isotope (radionuclide) is preferably chosen to have a half-life which is comparable to the time delay required in the said process between the marking operation and the process action to be taken, especially the identification step, i.e. of the order of a plurality of minutes to a plurality of hours.

The coating composition may further comprise a binder, such as to ensure fixation of the radioisotope on the marked object, in order to avoid any loss of the marking, or cross-contamination through the contact of a marked with unmarked objects. Said binder may noteworthy be present in extremely tiny amounts, such as to avoid any visible impact of the marking.

The said isotope is furthermore chosen such as to result in an easy detection of its presence at a certain distance, preferably by the way of a gamma-radiation of sufficient energy which is emitted during its radioactive decay. Isotopes having exclusively particle emissions, such as α- or β⁻-radiation, which are strongly absorbed by air or by any other material, render difficult a reliable and sensitive detection under all practical circumstances. Isotopes emitting β⁺-radiation are detectable, however, through the 511 keV electron-positron anihilation γ-radiation.

Half-life time and applied quantity of the said isotope ate chosen such as to result in a reliable detection under the required operating conditions, using state-of-the-art detection equipment. Reliable detection means that the detector signal obtained from the marking is preferably at least five standard deviations above background.

Radioactive decay events do noteworthy obey POISSON-type statistics, i.e. the standard deviation of a measured number of events is equal to the square root of the said number of events. Let B=the background (number of counts measured in an appropriate time interval Δt) in the absence of the marking, and S=the signal (number of counts measured in the same time interval Δt) in the presence of the marking, then the standard deviation c(S)=(S)^{1/2}. The condition for reliable detection, such as stated above, translates then into S>=5*(S)^{1/2}+B. For example, taking a background B of 10, a measured S of 50 will fulfill the set condition of a reliable detection.

From the stated above it is easily inferred that very low quantities of applied radioactive isotope will suffice to the marking purpose. This minimum of required radioactivity will have safely decayed below the background level after as few as three half-life times. The required activities for the marking are in all cases very much lower than those employed in medical radiographic applications.

The radioactive isotope is preferably chosen such as to allow its solubilization in the coating composition. The possibility to solubilize the isotope is hereby not only a function of the nature of the chemical species containing it—at the required low concentration levels everything is soluble—but depends principally on the chemical nature of the radioactive precursor material from which the isotope is drawn.

Short-lived radioactive isotopes can noteworthy only be handled in a practical application, if they can be generated in situ as decay (daughter) products of a longer lived radioactive parent isotope. In such a case, the short-lived isotope is in a secular equilibrium (i.e. where all concentration of the decay chain elements are at steady state) with its radioactive precursor, adopting the precursor's numerical activity and half-live time. As soon as the daughter isotope is separated from its parent, it decays according to its own, shorter live time.

This implies that the parent isotope must exist in a chemical form which allows an easy separation of the generated daughter product from its generating parent. Only few isotopes are known to fulfill all of the herein required conditions, which are noteworthy: i) to show a short-lived decay with emission of γ-radiation; ii) to have a sufficiently long-lived parent isotope; and iii) to have chemical properties which allow their easy separation from their parent isotope.

One of these isotopes, which has been extensively studied and which is used in medical applications, is 99m-Technetium. 99m-Tc is a γ-emitter with an energy of 142.68 keV, having a half life of 6.01 hours. This isotope is a metastable energy level in the β-decay of 99-Molybdenum to 99-Technetium. 99-Mo in turn has a half life time of 66 hours (2.75 days). 99-Mo is a fission product of 235-Uranium in nuclear reactors and is currently extracted from nuclear fuel irradiated in specially designed reactors. It can also be produced by high-flux neutron irradiation of a 98-Molybdenum target.

99m-Technetium generators, containing the 99-Mo precursor isotope in the chemical form of molybdate ions attached to an ion exchanger, to a gel or to a similar chromatographic support, are commercially available from radiopharmaceutical companies.

The 99m-Tc can be ‘milked’ from these generators by simple elution, in intervals corresponding to its replenishing through the decay of the parent 99-Mo. The useful life time of a 99m-Tc generator is about 5 half-life periods of the 99m-Mo precursor, i.e. about 2 weeks. After this time the generator has to be exchanged by a new one.

According to the present invention, the 99m-Tc obtained from a generator of this type is in situ mixed into the printing liquid in a controlled way, such as to obtain a liquid of controlled, standardized radioactivity.

The marking of an object in question is effectuated by applying a determined quantity of the said printing liquid to its surface. This can be done by any known method in the art; preferably by ink-jet printing or spraying methods of the drop-on-demand type, as these methods have no need for external (radioactive) ink recycling. The printing head's ink flux actuators can hereby be of the electromechanical or of the piezoelectric type; the ink is preferably internally cycled through the printing head, in order to keep its radioactivity level constant and to provide for the needed pressure gradient during the printing or marking operation.

The ‘printing’ operation can furthermore be performed either as a simple marking, or, alternatively, in the form of indicia, which might be read by corresponding radiation-sensitive area detection equipment within the life time of the used radioisotope. The printing or marking operation may be triggered upon receipt of a corresponding signal, preferably an electric signal.

The quantities of radioactive isotope which need to be applied for the marking according to the present invention are so small, that no toxicological issues are of concern, other than the direct radiation effects; in fact, the number of isotopic atoms deposited in the marking is far below the detection limit of most conventional analytical instruments, as well as far below the established chemical toxicity levels.

The total number of radioactive atoms N required in the marking can be calculated from the half-life t_{1/2} of the isotope and the desired initial absolute decay rate I₀ according to the formula N=1.44*I₀*t_{1/2}; the preferred absolute initial decay rate I₀ is lower than 1000 Becquerel (decays per second). Using an isotope with a half-life of 10 minutes, less than 1 Million atoms are required, corresponding to less than 1.6*10⁻¹⁸ mole.

The marking method according to the present invention is feasible with any short-lived radioactive isotope, which is a direct or an indirect daughter of a long-lived radioactive parent isotope, and for which a method of chemical separation is known. The following radioisotopes can noteworthy be used for alternative embodiments of the marking device:
60-Fe parent (half-life of 1.5 million years)
generates 60m-Co (half-life of 10.5 minutes) as the marker isotope, producing 60-Co (half-life of 5.27 years), which decays to the stable 60-Ni at a rate below the radioactive background level.
90-Sr parent (half-life of 28.79 years)
generates 90m-Y (half-life of 3.19 h) as the marker isotope, producing 90-Y (half-life of 64 h) which decays to the stable 90-Zr at a rate of 5% of the original activity level.
103-Ru parent (half-life of 39.26 days)
generates 103m-Rh (half-life of 56 minutes) as the marker isotope, producing the stable 103-Rh.
106-Ru parent (half-life of 373.6 days)
generates 106m-Rh (half-life of 131 minutes) as the marker isotope, producing 106-Rh (half-life of 29.8 sec) which decays to the stable 106-Pd immediately.
137-Cs parent (half-life of 30 years)
generates 137m-Ba (half-life of 2.55 minutes) as the marker isotope, producing the stable 137-Ba.
144-Ce parent (half-life of 285 days)
generates 144m-Pr (half-life of 7.2 minutes) as the marker isotope, producing 144-Pr (half-life of 17.28 minutes) which decays to the stable 144-Nd.

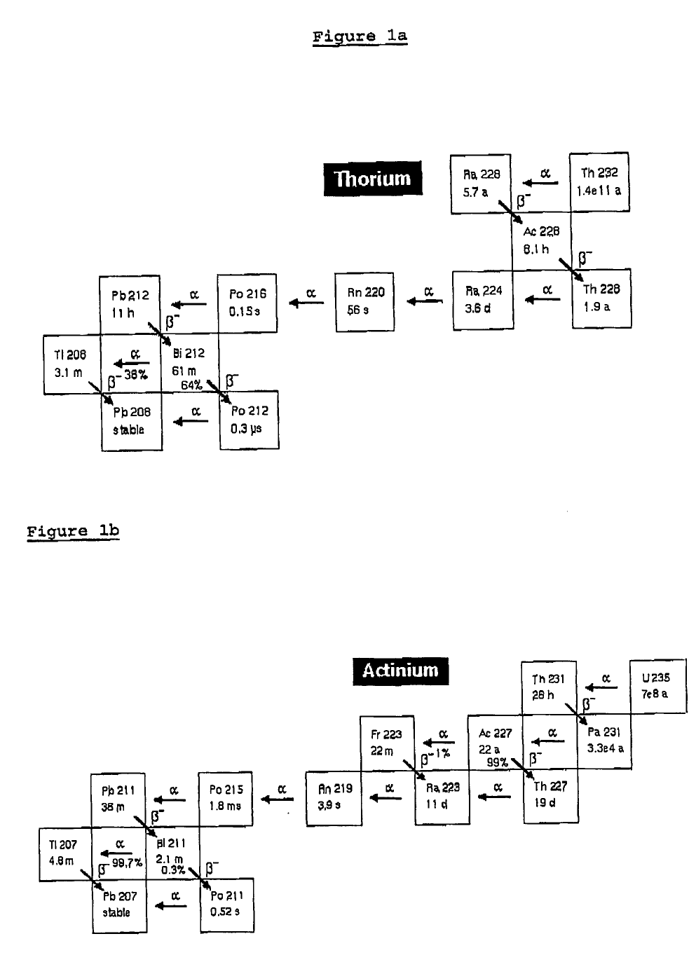

Another source of short-lived radioactivity which can be used in the context of the present invention, is 232-Thorium (half-life of 1.4*10¹⁰ years), or, preferably, its first direct daughter isotope 228-Radium (half-life of 5.7 years). FIG. 1a shows the decay scheme of the 232-Thorium radioactive family. The effective marker isotope is 212-Lead (212-Pb, half-life of 10.6 hours), which is in a secular equilibrium with its longer lived radioactive parents. A member in this equilibrium chain is the gaseous 220-Radon (Thoron, half-life of 55.6 sec), which can be used to draw the radioactivity via an air stream from the thorium or radium source, respectively, and to transfer it into the coating composition, where the 220-Rn decays to 212-Pb. The so produced radioactivity of the coating composition, due to 212-Pb, will have completely disappeared after about one week from switching off the device.

Still another source of suitable radioactivity is 235-Uranium (half-life of 7.0*108 years), or one of its daughter nuclei, preferably 227-Actinium (half-life of 21.77 years), which can be used as a generator for the marking isotope 211-Lead (211-Pb, with a half-life of 36.1 minutes). FIG. 1b shows the decay scheme of the 235-Uranium radioactive family. A member of the secular equilibrium chain, linking the 211-Pb to its longer lived radioactive parents, is the gaseous 219-Radon (half-life of 3.9 seconds). The Radon can be drawn from the generator by an air stream and introduced into the coating composition, where it decays to 211-Pb. The final product of the 211-Pb decay is the stable isotope 207-Pb. The so produced radioactivity of the coating composition, due to 211-Pb, will have completely disappeared after about 6 hours from switching off the device.

The isotope generator part is handled as an integrated, modular unit, purchased as such from an isotope facility; this means that no manipulations are performed on it at the user level, except using it according to its specifications. 99m-Tc generators need to be exchanged every two weeks; whereas a 228-Radium based 212-Pb generator will last for about 30 years, and an 227-Actinium based 211-Pb generator for about 100 years.

The equipment used to detect the marking of the invention is preferably a γ-detector of the scintillator- or of the semiconductor-type. In scintillator-detectors, a γ-quantum produced in the radioactive decay of a marker isotope is absorbed in a heavy-atom containing, optically transparent solid (e.g. a crystal of a material like NaI:Tl, CsI:Tl, BGO (bismuth germanate), CWO (cadmium tungstate), or PWO (lead tungstate)), producing a plurality of low-energy photons in the UV-, visible-, or NIR-spectral range. The number of photons produced is hereby more or less proportional to the energy of the original γ-quantum. The said photons are subsequently detected by a photomultiplyer tube, operated such as to discriminate the γ-rays according to their relative energies. The γ-rays falling into a preset energy window are taken as originating from the marker isotope and counted.

An interesting variant of scintillator detectors, such as described e.g. in U.S. Pat. No. 4,788,436, uses correspondingly doped optical fibers as the active absorber medium for the γ-rays. The generated photons travel, in both senses, down the fiber in which they were generated, to respective photomultipliers disposed at the ends of the fiber, where the corresponding light pulses are discriminated and counted. Optical fibers noteworthy allow to give in an easy way an almost arbitrary shape to the detecting interface, which can in consequence be made in the form of a gate or of any other convenient construction. Radiation-sensing optical fibers are commercially available from a number of suppliers, e.g. from Mitsubishi Electric.

Still another variant of γ-ray detectors is based on a direct charge carrier generation by the absorption of the γ-ray in an appropriate semiconductor material, such as Silicon, Germanium, CdZnTe₂, and others. In a further variant, a silicon photodiode is used in conjunction with a scintillator crystal. All these types of γ-ray detectors are known to the skilled in the art and commercially available from various sources, e.g. from Mitsubishi Electric; they need not, thus, to be further described here.

The invention comprises as well a system for temporarily marking an object and detecting said marking later in time for performing a specific action on said marked object. The system according to the invention comprises at least one device for temporary marking an object and at least one detecting device for detecting the presence of a temporary marking on an object. The marking device for applying the temporary marking comprises a short-lived-radionuclide generator, a first reservoir of a printing liquid, a radiation, monitor, a control unit and a printing or marking head. The marking device is activated upon receipt of a signal, e.g. an electric signal. The detecting device is capable of detecting of gamma-radiation and producing a signal, preferably an electric signal, upon detection of the said temporary marking. Said signal, e.g. an electric signal, may then be used to perform a specific action upon said marked object, such as taking it out of a stream of similar objects.

Preferably the marking device and the detecting device are locally separated from each other. In a preferred embodiment the marking device further comprises a splitting valve and/or a pump. In a further embodiment the marking device may comprise a second reservoir for storing a coating composition, preferably a printing ink, which does not contain any short-lived radioactive isotopes, i.e. which is free of the isotopes. This reservoir is used to refill the first reservoir and maintain an almost constant level of liquid within the first reservoir.

The system may comprise, if needed, a plurality of independent marking devices; it may also comprise, if needed, a plurality of independent detection devices. The marking, respectively detection devices may furthermore be either of the same or of different types, as to the used marker radionuclide and to the used detection hardware A marking device may also be associated with an external radiation detector in order to verify if the marking has been correctly applied.

Another aspect of the invention is a coating composition, preferably an ink-jet printing ink. The coating composition is characterized in that it comprises at least one short-lived radioactive isotope.

The coating composition and there especially the ink-jet printing ink comprises as a main component a liquid which can be a simple solvent, such as water, ethyl alcohol, isopropanol, mixtures thereof, or any other solvent or solvent mixture with easy evaporation. Preferably, however, the coating composition comprises minor amounts, i.e. less than 1% by weight, of additives, destined i) to enhance the wetting properties of the coating composition on the various substrates, ii) to fix the marking on the substrate, and iii) to prevent a foaming of the coating composition in the marking device. The additives for i) are selected from the classes of anionic, cationic or neutral surfactants; the additives for ii) are selected from the classes of water-soluble and solvent-soluble, non-crosslinkable binders, such as starch, polyvinyl alcohol, ethyl cellulose, acetyl cellulose, polyacrylic derivatives and the like. The amount of binder incorporated within the ink ranges at maximum up to 5 wt % referred to the total weight of the coating composition.

Preferably, the binder is used in a concentration of less than 2 wt % and even more preferred in a concentration of less than 0.1% by weight.; the additives for iii) are selected from the class of antifoaming agents. Depending on the application, further additives may be provided, such as bactericides, electrolytes, and the like.

Radioactive isotope being incorporated within the coating composition are identical to the ones describe before.

Still other embodiments of the invention, using other radioisotopes and/or other detecting equipment and/or other device lay-outs, can be easily conceived by the skilled in the art based on the disclosure given herein. The invention will now be outlined further with the help of the drawings and of an exemplary embodiment.

FIG. 1 a) shows the natural 232-Th decay chain
b) shows the natural '235-U/227-Ac decay chain

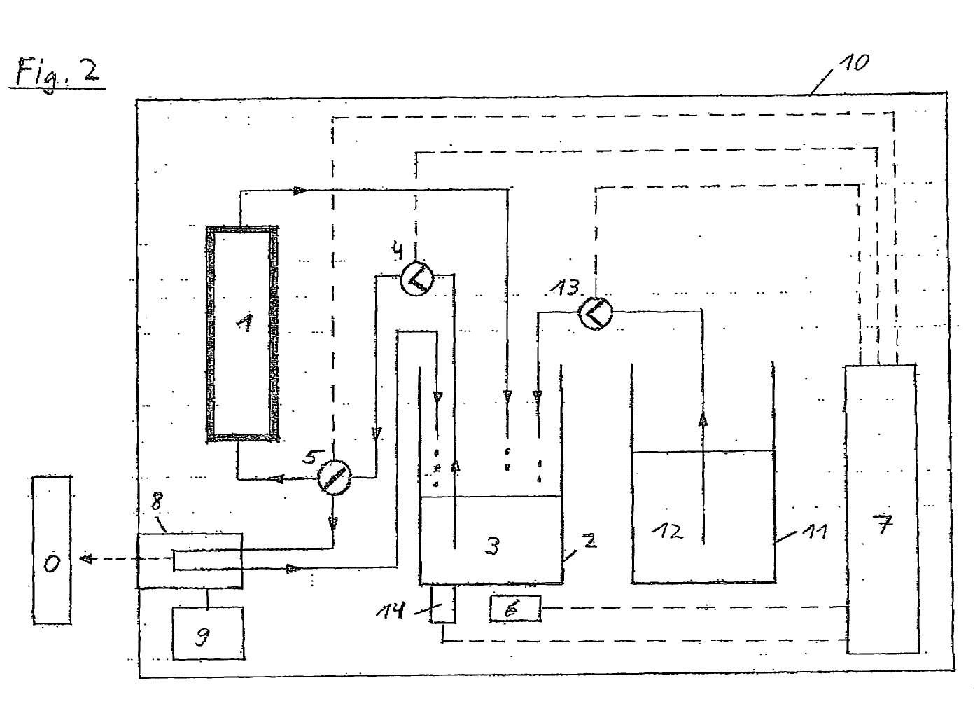

FIG. 2 schematically shows an embodiment using a 99m-Tc generator

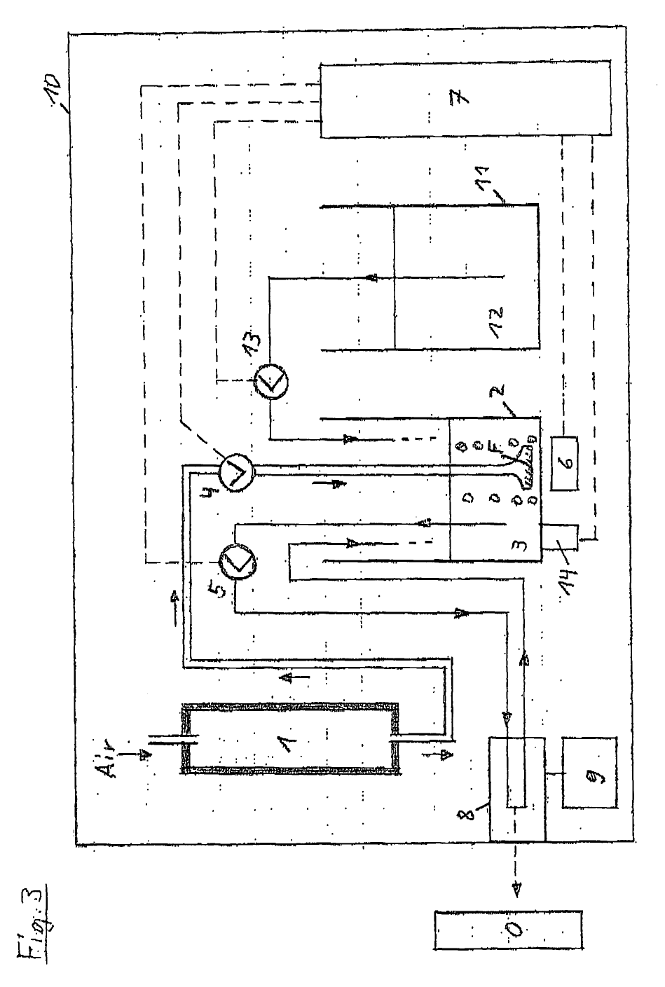

FIG. 3 schematically shows an embodiment using a 212-Pb generator

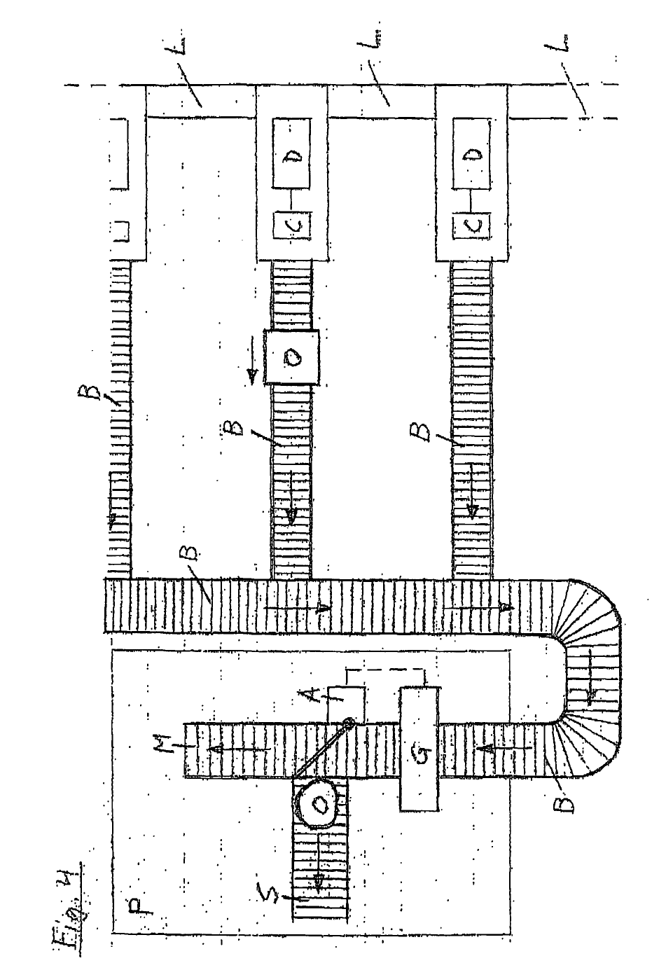

FIG. 4 schematically shows an application of a marking system according to the invention, comprising a marking device and a spatially separated automated detection device (gate).

### EXAMPLES

According to a first embodiment of a marking device for marking an object (O) according to the present invention and with reference to the scheme of FIG. 2, a shielded 99m-Tc generator (1) is employed as the source of the radioactive isotope. The marking device comprises further, in addition to the said source of radioactive isotope, a reservoir (2) containing a colorless printing liquid (3), a circulating pump (4), a splitting valve (5), a radiation monitor (6), a control unit (processor) (7), as well as a printing or marking head (8) with its corresponding control electronics (9). The printing liquid (3) in the reservoir (2), which is typically an ink-jet ink base without colorants nor pigments, is continuously circulated by the said circulating pump (4). A part of said printing liquid is deviated, via said splitting valve (5), through the said 99m-Tc generator (1), where it is loaded with 99m-Tc activity, before flowing back to the reservoir (2). The total 99m-Tc activity of the printing liquid in the reservoir is monitored by said radiation monitor (6) and said control unit (7), which is in turn enabled to actuate said splitting valve (5) so that the resulting 99m-Tc activity of the printing liquid (3) remains at a predetermined level. The whole device is contained within an appropriate radiation shielding (10), such that no radiation hazard is created for the operating personnel. The total volume of radioactive ink (3) in the device is advantageously kept small, and a second, non-radioactive ink reservoir (11) may be provided, for replenishing the ink reservoir (2) with non-radioactive fluid (12) upon need, by the means of a dosing pump (13) and a level sensor (14) which are both controlled by the said processor (7).

If the marking device is switched off, the 99m-Tc activity of the printing fluid decays according to the half-life of the 99m-Tc isotope of 6 hours, i.e. to about 12.5% of its initial value after one day, to 1.5% after two days, and to 0.2% after three days of waiting. This means that after a waiting period of some days, no significant radioactivity is any longer present in the equipment, except in the shielded 99m-Tc generator, such that the equipment can be freely serviced or repaired.

After the decay of the 99m-Tc in the marking, the resulting 99-Tc isotope is radioactive as well, decaying to the stable 99-Ru with a half-life of 210'000 years. However, at the employed quantities, this long-term activity is absolutely harmless, and its contribution is actually negligible compared with the background radioactivity present in all living being, which is due to the naturally occurring radioactive isotope 40-K (0.0117% of the natural potassium; half life of 1.28*10⁹ years; β⁻-, β⁺-, and γ-emitter); potassium being a necessary constituent of life on earth.

According to a second embodiment and with reference to the scheme of FIG. 3, the marking device for marking an object (O) according to the present invention comprises a 228-Radium based 212-Pb generator as the source of the radioactive marking isotope. The 228-Ra is contained in a dry and shielded generator package (1), where it is in a secular equilibrium with its daughter nuclei, noteworthy with the gaseous 220-Radon (Thoron, half-life of 55.6 sec). The device comprises further a reservoir (2) containing a colorless printing liquid (3), an air pump (4), a circulating pump (5), a radiation monitor (6), a control unit (processor) (7), as well as a printing or marking head (8) with its corresponding control electronics (9). The printing liquid (3) in the reservoir (2), which is typically an ink-jet ink base without colorants nor pigments, is continuously circulated through the printing head (8) by the pump (5). Controlled by the processor (7), air containing 220-Radon is drawn from the generator package by the means of the air pump (4), and bubbled through the liquid (3) with the help of a porous fritted glass interface (F). The total “220-Rn and daughters” activity of the printing liquid (3) in the reservoir (2) is monitored with the radiation monitor (6) and the processor (7), which is enabled to act on the air pump (4) such that the resulting, mainly 212-Pb originated radioactivity of the printing liquid stays at a predetermined level. The whole device is contained in an appropriate radiation shielding (10), such that no radiation hazard is created for the operating personnel. The total volume of radioactive ink (3) in the device is advantageously kept small, and a second, non-radioactive ink reservoir (11) may be provided, for replenishing the ink reservoir (2) with non-radioactive fluid (12) upon need, by the means of a dosing pump (13) and a level sensor (14) which are both controlled by the said processor (7).

The printing liquid essentially contains only short-lived isotopes, 212-Pb having the longest half-life (10.6 hours) of all of them. After switching off the device, the activity of the marking liquid drops after one day to 21%, after two days to 4.3%, and after three days to 0.9% of its original value. This means that after a waiting period of about a week, no significant radioactivity is any longer present in the equipment, except in the shielded generator part, such that the equipment can be freely serviced or repaired. The final product of the 212-Pb decay is stable 208-Pb.

An marking & detecting system according to the invention, with reference to the scheme of FIG. 4, comprising a plurality of marking stations and a single detection station is embodied as follows:

A locket hall of a post office comprises a series of lockets (L). A marking device (D) according to the invention (e.g. FIG. 2) is located at each locket (L), at the point where objects (O) are accepted for weighing and shipping. During the weighing operation, and triggered by an electric signal, an invisible radioactive and fast-drying ink-jet mark may be applied to the lower part of the object (O). The request to mark a determined object (O) may hereby either be given manually, or it may be automatically generated as a consequence of the fulfillment of predetermined conditions such as the destination of the object. Immediately after the marking operation, the object passes over a γ-counter (C), connected to the marking device (D). If the applied mark is detected by the γ-counter (C), the marking operation is assumed to be successfully concluded, and the object (O) is sent via a conveyor belt (B) to a central collection point (P). If no marking is detected by counter (C) for an presumably marked object, a failure alert is given, allowing the operating personnel of the locket to take the appropriate measures.

At the central collection point (P), the objects pass a gate (G), comprising a scintillator detector and corresponding processing electronics for detecting, discriminating and counting γ-radiation. The gate (G) is further connected to a mechanical actuator (A) for deviating objects (O) from the main track (M) to a secondary track (S), if required. Upon detection of γ-radiation corresponding to a marking on an object (O), the mechanical actuator is set such as to deviate the marked object (O) from the mainstream to the secondary track (S). The in this way separated objects are conveyed to an examination station (not shown), where they are subject to X-ray scanning and/or other appropriate detecting operations, and where they can also be manually examined, if needed, before giving them their final destination. The unmarked objects, in turn, are passed straight on via the main track (M), to be charged on board of a transportation vehicle.

The skilled in the art may conceive, based on the disclosure made herein, many other variants of the marking method, the marking device and the marking & detection system.

1. A method for temporary marking an object (O) in a process chain, the method comprising the step of applying a coating composition (3) to the object (O) by a marking device, the said coating composition (3) comprising a short-lived radioactive isotope, wherein said short-lived radioactive isotope is generated in situ from a longer-lived radioactive precursor isotope and added to said coating composition (3) in said marking device.

2. Method according to claim 1, characterized in that said short-lived radioactive isotope has a half-life time comprised between a minute and a day.

3. Method according to claim 1 or 2, characterized in that said short-lived radioactive isotope is a gamma-radiation emitter or a β(+)-emitter.

4. Method according to one of claims 1 to 3, characterized in that the short-lived radioactive isotope is selected from the group comprising 99m-Tc, 60m-Co, 90m-Y, 103m-Rh, 106m-Rh, 137m-Ba, 144m-Pr, 144-Pr, 212-Pb, and 211-Pb.

5. Method according to one of the preceding claims, characterized in that the coating composition (3) is applied to said object (O) by ink-jet printing or by a spraying operation.

6. Method according to claim 5, characterized in that said ink-jet printing or spraying is of the drop-on-demand type.

7. Method according to one of the preceding claims, characterized in that said coating composition (3) contains at least one binder.

8. Method according to one of the preceding claims, characterized in that the application of the coating composition (3) is performed upon receipt of a particular signal, preferably an electric signal, by said marking device.

9. Device suitable for temporary marking an object (O) in a process chain, said device comprising a short-lived radionuclide generator (1), a first reservoir (2) of a printing liquid, a splitting valve (5), a radiation monitor (6), a control unit (7) and a printing or marking head (8).

10. Device according to claim 9, wherein said radionuclide generator (1) generates a gamma-emitting or β(+)-emitting radioactive isotope, said radioactive isotope having a half-life time comprised between a minute and a day.

11. Device according to claim 10, wherein said radionuclide generator (1) generates a gamma-emitting short-lived radioactive isotope, which is preferably selected from the group comprising 99m-Tc, 60m-Co, 90m-Y, 103m-Rh, 106m-Rh, 137m-Ba, 144m-Pr, 144-Pr, 212-Pb, and 211-Pb.

12. Device according to one of the claims 9 to 11, wherein said printing or marking head (8) is an ink-jet printing head, preferably a drop-on-demand ink-jet printing head.

13. Device according to one of the claims 9 to 12, wherein said device comprises further a second reservoir (11), containing printing liquid, and a dosing pump (13), the printing liquid being free of radioactive isotopes.

14. A system for temporary marking an object (O) in a process chain, said system comprising
a) at least one device for temporary marking an object (O), preferably a device according to one of the claims 9 to 13; and
b) at least one detecting device for detecting the presence of the temporary marking on an object (O),
wherein the device for applying the temporary marking comprises a short-lived radionuclide generator (1), a first reservoir (2) of a printing liquid, a splitting valve (5), a radiation monitor (6), a control unit (7) and a printing or marking head (8),
wherein the device is activated upon receipt of a signal, preferably an electric signal, and
wherein the detecting device is capable of detecting gamma-radiation, and producing a signal, preferably an electric signal, upon detection of said temporary marking.

15. A method for temporary marking and identifying an object (O), the method comprising the steps of
applying a coating composition (3) to the object (O), by a marking device, wherein the coating composition (3) comprises a short-lived radioactive isotope; and
identifying the temporary marking by detecting gamma-radiation emitted by the short-lived radioactive isotope;
wherein said short-lived radioactive isotope is generated in situ from a longer-lived radioactive precursor isotope and added to said coating composition (3) in said marking device.

16. Use of a short-lived radioactive isotope in an ink or coating composition for temporarily marking and identifying an object (O) in a process chain, wherein said short-lived radioactive isotope is generated in situ from a longer-lived radioactive precursor isotope and added to said coating composition (3) in said marking device.
